(19) United States
(12) Patent Application Publication
(10) Pub. No.: US 2010/0187989 A1
(43) Pub. Date: Jul. 29, 2010

(54) INORGANIC ELECTROLUMINESCENT DEVICE AND DISPLAY DEVICE INCLUDING SAME

(75) Inventors: Ha-jin KIM, Suwon-si (KR); Shang-hyeun PARK, Yongin-si (KR); Min-jong BAE, Yongin-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/533,195

(22) Filed: Jul. 31, 2009

(30) Foreign Application Priority Data
Jan. 23, 2009 (KR) 10-2009-0006018

(51) Int. Cl. H01J 1/62

(52) U.S. Cl. 313/509

(57) ABSTRACT

An inorganic electroluminescent device includes a first electrode, a nano-coil layer disposed on the first electrode, a dielectric layer disposed on the nano-coil layer, a fluorescent layer disposed on the dielectric layer and a second electrode disposed on the fluorescent layer.

### CROSS-REFERENCE TO RELATED APPLICATION

This application claims priority to Korean Patent Application No. 10-2009-0006018, filed on Jan. 23, 2009, and all the benefits accruing therefrom under 35 U.S.C. §119, the content of which in its entirety is herein incorporated by reference.

### BACKGROUND

1) Field

The following description relates to an inorganic electroluminescent (“EL”) device and, more particularly, to a display apparatus including the inorganic EL device.

2) Description of the Related Art

In general, electroluminescent (“EL”) devices, which utilize a phenomenon of changing electrical energy to light energy, are used as lamp-type light sources or as active light emitting display devices. EL devices are typically classified as either organic EL devices or inorganic EL devices, depending on a type of material included in a light emitting layer of the given EL device. Powder type inorganic EL devices are used as light sources for keypads of mobile phones, sign boards or medical equipment, for example. However, inorganic EL devices have low brightness, as compared to other types of EL devices, and it is therefore difficult to utilize the inorganic EL devices in display apparatuses. Moreover, as display apparatuses become larger, demand for improving brightness of the inorganic EL devices is increasing.

### SUMMARY

The general inventive concept relates to an inorganic electroluminescent (“EL”) device having a substantially improved brightness.

Exemplary embodiments include a display apparatus including an inorganic EL device having a substantially improved brightness.

Exemplary embodiments include an inorganic EL device including: a first electrode disposed; a nano-coil layer disposed on the first electrode; a dielectric layer disposed on the nano-coil layer; a fluorescent layer disposed on the dielectric layer; and a second electrode disposed on the fluorescent layer.

The EL device may further include a substrate, on which the first electrode is disposed.

An alternating current (“AC”) voltage may be applied to the first electrode and/or the second electrode.

The nano-coil layer may include carbon nano-coils.

The fluorescent layer may include a powder type fluorescent material.

The first electrode and/or the second electrode may be a transparent electrode.

The nano-coil layer may be formed by a chemical vapor deposition (“CVD”) method or a screen printing method.

Alternative exemplary embodiments include an inorganic EL device including: a first electrode; a dielectric layer disposed on the first electrode; a nano-coil layer disposed on the dielectric layer; a fluorescent layer disposed on the nano-coil layer; and a second electrode disposed on the fluorescent layer.

The EL device may further include a substrate, on which the first electrode is disposed.

An AC voltage may be applied to the first electrode and/or the second electrode.

The nano-coil layer may include carbon nano-coils.

The fluorescent layer may include a powder type fluorescent material.

The first electrode and/or the second electrode may be a transparent electrode.

The nano-coil layer may be formed by a CVD method or a screen printing method.

Additional exemplary embodiments include a display apparatus including: a first electrode array including a first electrode disposed along a first direction; a nano-coil layer disposed on the first electrode array; a dielectric layer disposed on the nano-coil layer; a fluorescent layer disposed on the dielectric layer; a second electrode array disposed on the fluorescent layer and including a second electrode disposed along a second direction, the second direction crossing the first direction.

An AC voltage may be applied to the first electrode and/or the second electrode.

The nano-coil layer may include carbon nano-coils.

The fluorescent layer may include a powder type fluorescent material.

The first electrode and/or the second electrode may be a transparent electrode.

The nano-coil layer may be formed by a CVD method or a screen printing method.

### BRIEF DESCRIPTION OF THE DRAWINGS

The above and/or other aspects, features and advantages of the present invention will become more readily apparent by describing in further detail exemplary embodiments thereof, taken in conjunction with the accompanying drawings, in which:

FIG. 1 is a cross-sectional view of an exemplary embodiment of an inorganic electroluminescent (“EL”) device according to the present invention;

FIG. 2 is an exploded view of an exemplary embodiment of a nano-coil layer included in the inorganic EL device of FIG. 1;

FIG. 3 is an electron microscope photograph of the nano-coil layer of FIG. 2;

FIG. 4 is a graph of brightness versus voltage applied to both the inorganic EL device of FIG. 1, and to an inorganic EL device without a nano-coil layer;

FIG. 5 is a graph of brightness versus frequency of a voltage applied to both the inorganic EL device illustrated in FIG. 1, and to an inorganic EL device without a nano-coil layer;

FIG. 6 is a cross-sectional view of an alternative exemplary embodiment of an inorganic EL device according to the present invention; and

FIG. 7 is a plan view of an exemplary embodiment of a display apparatus according to the present invention.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, exemplary embodiments of the present invention will be described in further detail with reference to the accompanying drawings. An inorganic electroluminescent (“EL”) device according to exemplary embodiments described herein includes, but is not limited to, a nano-coil layer and a fluorescent layer which emits light.

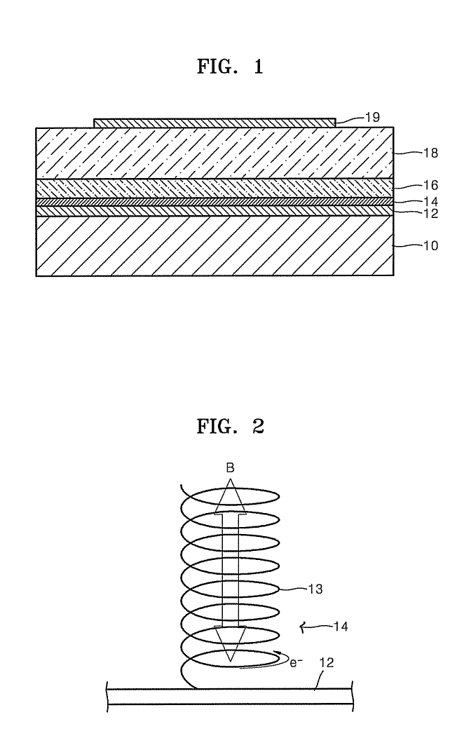

Referring to FIG. 1, which is a cross-sectional view of an exemplary embodiment of an inorganic EL device according to the present invention, the inorganic EL device according to an exemplary embodiment includes a nano-coil layer 14 disposed on a first electrode 12, and a dielectric layer 16 disposed on the nano-coil layer 14. A fluorescent layer 18 is disposed on the dielectric layer 16, and a second electrode 19 is disposed on the fluorescent layer 18. In addition, a substrate 10 may be disposed under the first electrode 12, e.g., the first electrode 12 may be disposed on the substrate 10. The first electrode 12 and/or the second electrode 19 may be a transparent electrode. The electrode through which light is emitted, .e.g., either the first electrode 12 or the second electrode 19 having light emitted therethrough, may be the transparent electrode. In an alternative exemplary embodiment, however, both the first electrode 12 and the second electrode 19 may be transparent electrodes. In the exemplary embodiment shown in FIG. 1, for example, the inorganic EL device is a top view type light emitting device, in which light is emitted upward. Accordingly, the second electrode 19 is the transparent electrode. On the other hand, in a bottom view type light emitting device in which light is emitted downward, the electrode located at a lower portion of the device, e.g., the first electrode 12, is the transparent electrode. In another alternative exemplary embodiment, both the first electrode 12 and the second 19 may be transparent electrodes. The transparent electrode or electrodes may include indium tin oxide (“ITO”), for example. An alternating current “(AC”) voltage may be applied to the first electrode 12 and/or the second electrode 19.

In an exemplary embodiment, the fluorescent layer 18 includes a powder type fluorescent material. In addition, the dielectric layer 16 and/or the fluorescent layer 18 may be fabricated by a screen printing method, a spin coating method and/or a thin film deposition method, for example, but alternative exemplary embodiments are not limited thereto.

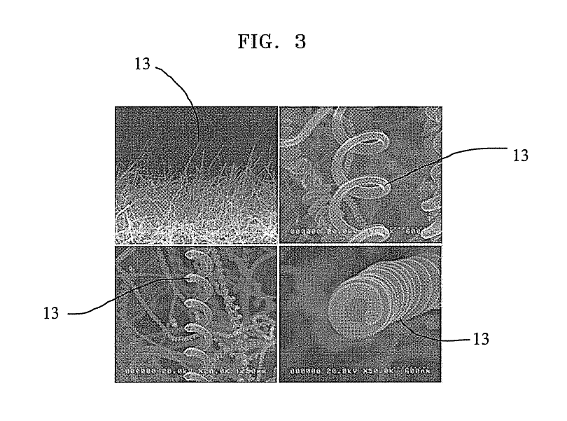

In an exemplary embodiment, the nano-coil layer 14 is disposed on the first electrode 12 and may include carbon nano coils, for example. FIG. 2, which is an exploded view of an exemplary embodiment of a nano-coil layer included in the inorganic EL device of FIG. 1, shows the nano-coil layer 14 disposed on the first electrode 12. As shown in FIG. 2, the nano-coil layer 14 may include nano-coils 13. In an exemplary embodiment, the nano-coil layer 14 may be formed by a screen printing method or a chemical vapor deposition (“CVD”) method, for example, but alternative exemplary embodiments are not limited thereto.

FIG. 3 is an electron microscope photograph of the carbon nano-coil layer of FIG. 2. The nano-coils 13 may be fabricated by using any of the abovementioned methods, for example, but the fabrication method of the nano-coils is not limited thereto.

An operation of the inorganic EL device according to an exemplary embodiment will now be described in further with reference to FIGS. 1 and 2. When a voltage is applied to the inorganic EL device, an electric field is generated, and electrons e⁻ bounce out of, e.g., exit, the dielectric layer 16 and are accelerated by the electric field. The electrons e⁻ collide with fluorescent material in the fluorescent layer 18 to emit light. The fluorescent layer 18 emits light when a strength of the electric field is greater than or equal to a selected threshold value, while the fluorescent layer 18 does not emit light when the strength of the electric field generated is less than the threshold value. Therefore, when a voltage equal to a threshold voltage or greater is applied to the device, light is emitted. Referring to FIG. 2, when the AC voltage is applied to the nano-coil layer 14, a local magnetic field B is generated in the nano-coils 13. The electrons e⁻ accelerate due to Lorentz force generated by the local magnetic field B. When the electrons e⁻ accelerate, the electrons e⁻ collide with the fluorescent material in the fluorescent layer 18 with an increased force, and thus, an intensity of light emitted by the fluorescent layer 18 substantially increases and a brightness of the inorganic EL device according to an exemplary embodiment is substantially improved.

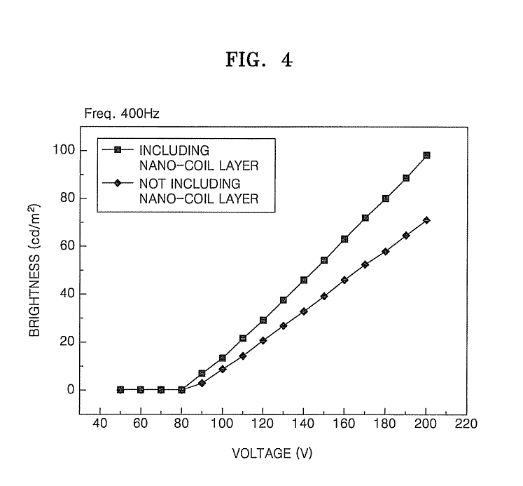

FIG. 4, which is a graph of brightness versus voltage applied to both the inorganic EL device of FIG. 1, and to an inorganic EL device without a nano-coil layer, generally shows brightness, in candela per square meter (cd/m²), according to a driving voltage. More particularly, FIG. 4 illustrates a brightness of the inorganic EL device including the nano-coil layer 14 according to an exemplary embodiment compared with a brightness of an inorganic EL device which does not include the nano-coil layer 14. In FIG. 4, a frequency of AC voltage applied is about 400 hertz (Hz). As shown in FIG. 4, for a given driving voltage, the brightness of the inorganic EL device including the nano-coil layer 14 according to an exemplary embodiment is substantially greater than the brightness of the inorganic EL device which does not include the nano-coil layer 14.

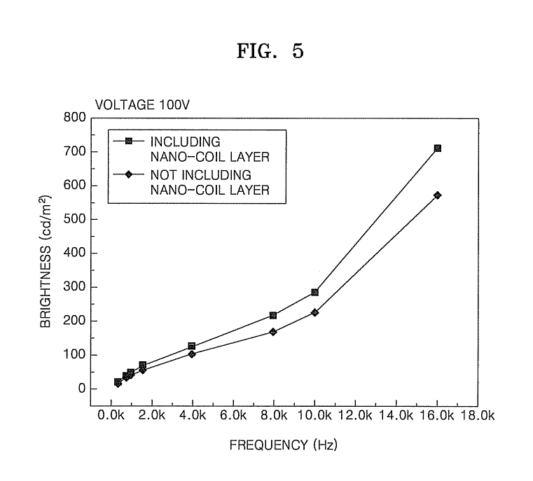

FIG. 5, which is a graph of brightness versus frequency, shows brightness according to the frequency of AC voltage applied, when the driving voltage is 100 volts (V), for both the inorganic EL device including the nano-coil layer 14 according to an exemplary embodiment and to the inorganic EL device which does not include the nano-coil layer 14. As shown in FIG. 5, for a given frequency of the AC voltage applied, the brightness of the inorganic EL device including the nano-coil layer 14 according to an exemplary embodiment is substantially greater than the brightness of the inorganic EL device which does not include the nano-coil layer.

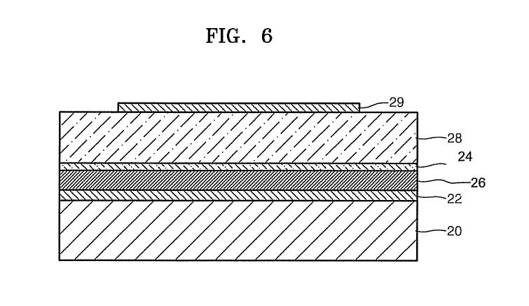

FIG. 6 is a cross-sectional view of an alternative exemplary embodiment of an inorganic EL device according to the present invention. The inorganic EL device according to an exemplary embodiment includes a first electrode 22, a dielectric layer 24 disposed on the first electrode 22, a nano-coil layer 26 disposed on the dielectric layer 24, a fluorescent layer 28 disposed on the nano-coil layer 26, and a second electrode 29. In addition, a substrate 20 may be disposed under the first electrode 22, e.g., the first electrode 22 may be disposed on the substrate 20.

In an exemplary embodiment, the first electrode 22 and/or the second electrode 29 may be a transparent electrode, as described in greater detail above. In addition, an AC voltage may be applied to the first electrode 22 and/or the second electrode 29, as also described in greater detail above.

When an electric field is applied to the nano-coil layer 24, an effective work function of the nano-coil layer 24 is substantially changed, and electrons bounce out of, e.g., exit, nano-coils (best shown in FIG. 2) of the nano-coil layer 24 due to a tunneling phenomenon, and due to field emission, which is stronger at a tip of the nano-coils. Therefore, a light emitting efficiency of a display device according to an exemplary embodiment is substantially improved due to the field emission, strengthened by the nano-coils. Therefore, a brightness of the inorganic EL device according to an exemplary embodiment substantially increases, and the inorganic EL device according to an exemplary embodiment substantially may be effectively and efficiently included in a large display apparatus, such as a display apparatus larger than a keypad of a mobile phone, for example, but not being limited thereto.

A display apparatus according to an exemplary embodiment will now be described in further detail with reference to FIGS. 1, 6 and 7.

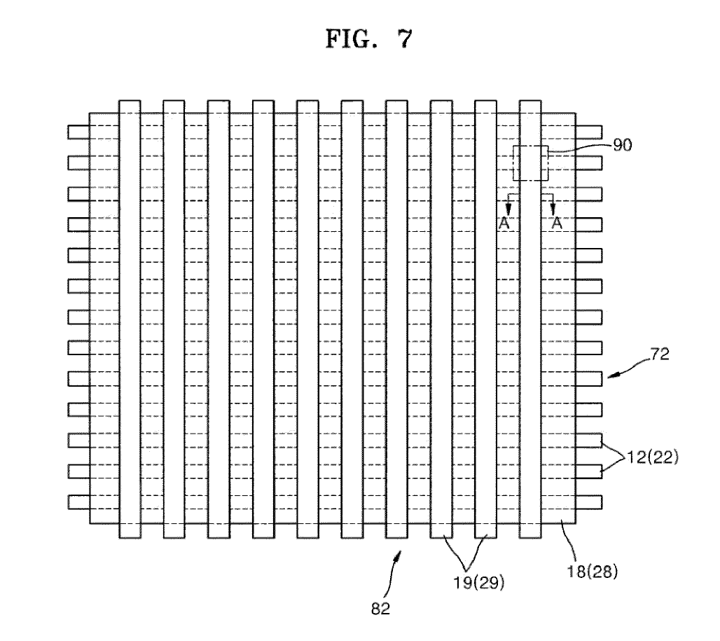

FIG. 7 is a plan view of an exemplary embodiment of a display apparatus according to the present invention. Referring to FIGS. 1, 6 and 7, the display apparatus according to an exemplary embodiment includes a first electrode array 72 including first electrodes 12 (FIG. 1) or 22 (FIG. 6) arranged as stripes, e.g., disposed in an elongated rectilinear manner in a first direction along a longitudinal axis thereof, and a second electrode array 82 including second electrodes 19 (FIG. 1) or 29 (FIG. 6), also arranged as stripes aligned in a second direction that crosses the first direction, e.g., substantially perpendicular to the first electrodes 12 or 22. The first electrode array 72 and the second electrode array 82 are disposed to cross each other, as shown in FIG. 7. Moreover, in an exemplary embodiment, portions where a given first electrode 12 or 22 crosses a corresponding second electrode 19 or 29 define pixels 90. A cross-section, taken along line A-A of FIG. 7, of each pixel 90 includes a structure as described in further detail above with reference to FIG. 1 or FIG. 6. Specifically, for example, as shown in FIG. 1, the nano-coil layer 14 is disposed between the first electrode 12 and the second electrode 19, and the dielectric layer 16 and the fluorescent layer 18 may be disposed between the nano-coil layer 14 and the second electrode layer 19. Alternatively, and referring to FIG. 6, the dielectric layer 24, the nano-coil layer 26, and the fluorescent layer 28 may be disposed between the first electrode 22 and the second electrode 29. In addition, the substrate 10 or 20 may be disposed under the first electrode array 72.

To apply a voltage to a selected pixel 90 in the display apparatus according to an exemplary embodiment, a voltage is selectively applied to one electrode in the first electrode array 72, corresponding to the selected pixel 90, and to one electrode in the second electrode array 82, corresponding to the selected pixel 90. When the voltage is applied to the selected pixel 90, an electric field is generated in the selected pixel 90 and the fluorescent layer 18 or 28 of the selected pixel 90 emits light to display an image. In the display apparatus according to an exemplary embodiment, the nano-coil layer 14 or 24 is disposed between the first electrode 22 or 24 and the dielectric layer 16 or 26 or, alternatively, between the dielectric layer 16 or 26 and the fluorescent layer 22 or 24 to substantially improve brightness of the display apparatus. It will be noted that, while a passive matrix display apparatus is shown in FIG. 7, alternative exemplary embodiments are not limited thereto. Rather, alternative exemplary embodiments may include an active matrix display apparatus, for example.

Thus, an inorganic EL device including a nano-coil layer and a display apparatus including the inorganic EL device according to exemplary embodiments provides advantages which include, but are not limited to, substantially increased brightness.

The present invention should not be construed as being limited to the exemplary embodiments set forth herein. Rather, these exemplary embodiments are provided so that this disclosure will be thorough and complete and will fully convey the concept of the present invention to those skilled in the art.

While the present invention has been particularly shown and described with reference to exemplary embodiments thereof, it will be understood by those of ordinary skill in the art that various changes in form and details may be made therein without departing from the spirit or scope of the present invention as defined by the following claims.

What is claimed is:

1. An inorganic electroluminescent device comprising:
a first electrode;
a nano-coil layer disposed on the first electrode;
a dielectric layer disposed on the nano-coil layer;
a fluorescent layer disposed on the dielectric layer; and
a second electrode disposed on the fluorescent layer.

2. The inorganic electroluminescent device of claim 1, further comprising a substrate on which the first electrode is disposed.

3. The inorganic electroluminescent device of claim 1, wherein an alternating current voltage is applied to at least one of the first electrode and the second electrode.

4. The inorganic electroluminescent device of claim 1, wherein the nano-coil layer comprises carbon nano-coils.

5. The inorganic electroluminescent device of claim 1, wherein the fluorescent layer comprises a powder type fluorescent material.

6. The inorganic electroluminescent device of claim 1, wherein at least one of the first electrode and the second electrode comprises a transparent electrode.

7. The inorganic electroluminescent device of claim 1, wherein the nano-coil layer is formed by one of a chemical vapor deposition method and a screen printing method.

8. An inorganic electroluminescent device comprising:
a first electrode;
a dielectric layer disposed on the first electrode;
a nano-coil layer disposed on the dielectric layer;
a fluorescent layer disposed on the nano-coil layer; and
a second electrode disposed on the fluorescent layer.

9. The inorganic electroluminescent device of claim 8, further comprising a substrate on which the first electrode is disposed.

10. The inorganic electroluminescent device of claim 8, wherein an alternating current voltage is applied to at least one of the first electrode and the second electrode.

11. The inorganic electroluminescent device of claim 8, wherein the nano-coil layer comprises carbon nano-coils.

12. The inorganic electroluminescent device of claim 8, wherein the fluorescent layer comprises a powder type fluorescent material.

13. The inorganic electroluminescent device of claim 8, wherein at least one of the first electrode and the second electrode comprises a transparent electrode.

14. The inorganic electroluminescent device of claim 8, wherein the nano-coil layer is formed by one of a chemical vapor deposition method and a screen printing method.

15. A display apparatus comprising:
a first electrode array including a first electrode disposed along a first direction;
a nano-coil layer disposed on the first electrode array;
a dielectric layer disposed on the nano-coil layer;
a fluorescent layer disposed on the dielectric layer;
a second electrode array disposed on the fluorescent layer and including a second electrode disposed along a second direction, the second direction crossing the first direction.

16. The display apparatus of claim 15, wherein an alternating current voltage is applied to at least one of the first electrodes and the second electrodes.

17. The display apparatus of claim 15, wherein the nano-coil layer comprises carbon nano-coils.

18. The display apparatus of claim 15, wherein the fluorescent layer comprises a powder type fluorescent material.

19. The display apparatus of claim 15, wherein at least one of the first electrode and the second electrode comprises a transparent electrode.

20. The display apparatus of claim 15, wherein the nano-coil layer is formed by one of a chemical vapor deposition method and a screen printing method.
